(19) United States
(12) Patent Application Publication
(10) Pub. No.: US 2026/0036681 A1
(43) Pub. Date: Feb. 5, 2026

(54) METHOD TO IMPROVE MEASUREMENT ACCURACY FOR BEAM SCANNING APPLICATION

(71) Applicant: Lumentum Operations LLC, San Jose, CA (US)

(72) Inventors: Sylvain LEDUC, Gatineau (CA); Alan HNATIW, Ottawa (CA)

(21) Appl. No.: 18/897,325

(22) Filed: Sep. 26, 2024

Related U.S. Application Data
(60) Provisional application No. 63/678,305, filed on Aug. 1, 2024.

(51) Int. Cl. G01S 7/481; G01S 17/42

(52) U.S. Cl. CPC G01S 7/4817; G01S 17/42

(57) ABSTRACT

A beam scanning method includes acquiring, by one or more acquisition elements, measurements of a reflected light beam based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner; reading, by a main processor, a processor instruction set comprising a plurality of program instructions and a plurality of first acquisition instructions; generating, by the main processor for an acquisition engine, a plurality of second acquisition instructions based on the plurality of first acquisition instructions; executing, by the main processor, the plurality of program instructions during a scanning operation; and executing, by the acquisition engine, the second plurality of acquisition instructions during the scanning operation.

### CROSS-REFERENCE TO RELATED APPLICATION

This Patent application claims priority to U.S. Provisional Patent Application No. 63/678,305, filed on Aug. 1, 2024, and entitled “METHOD TO IMPROVE MEASUREMENT ACCURACY FOR BEAM SCANNING APPLICATION.” The disclosure of the prior Application is considered part of and is incorporated by reference into this Patent Application.

### TECHNICAL FIELD

The present disclosure relates generally to improved measurement accuracy for a beam scanning application.

### BACKGROUND

A scanning system may use two-dimensional (2D) scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Transmitted light beams may be reflected back to the scanning system from one or more objects in the FOV as reflected light beams. A three-dimensional (3D) image of a scanned scene or a scanned object can then be generated based on distance measurements corresponding to the transmitted/reflected light beams. Additionally, or alternatively, the reflected light beams may be used by the scanning system to detect objects within the FOV for further processing.

### SUMMARY

In some implementations, a beam scanning system includes a light transmitter configured to transmit a light beam; a beam scanner configured to direct the light beam over a range of angles based on a scanning pattern; a detector comprising one or more acquisition elements configured to acquire measurements of a reflected light beam, corresponding to the light beam, based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner, wherein the detector comprises a signal processor configured to, based on the measurements, calculate distances to a target from which the reflected light beam is reflected; and a control system comprising a main processor and an acquisition engine coupled to the main processor, wherein the main processor is configured to read a processor instruction set comprising a plurality of program instructions and a plurality of first acquisition instructions, wherein the main processor is configured to execute the plurality of program instructions during a scanning operation, wherein the main processor is configured to generate a plurality of second acquisition instructions based on the plurality of first acquisition instructions and provide the plurality of second acquisition instructions to the acquisition engine, and wherein the acquisition engine is configured to execute the second plurality of acquisition instructions during the scanning operation.

In some implementations, a beam scanning system includes a light transmitter configured to transmit a light beam; a beam scanner configured to direct the light beam over a range of angles based on a scanning pattern; a detector comprising one or more acquisition elements configured to acquire measurements of a reflected light beam, corresponding to the light beam, based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner, wherein the detector comprises a signal processor configured to, based on the measurements, calculate distances to a target from which the reflected light beam is reflected; and a control system comprising a main processor and an acquisition engine coupled to the main processor, wherein the main processor is configured to read a processor instruction set comprising a plurality of program instructions and a plurality of acquisition instructions, wherein the main processor is configured to execute the plurality of program instructions during a scanning operation, wherein the main processor is configured to preconfigure the acquisition engine with the plurality of acquisition instructions, and wherein the acquisition engine is configured to execute the plurality of acquisition instructions during the scanning operation.

In some implementations, a beam scanning method includes transmitting, by a light transmitter, a light beam; directing, by a beam scanner, the light beam over a range of angles based on a scanning pattern; acquiring, by one or more acquisition elements, measurements of a reflected light beam based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner; reading, by a main processor, a processor instruction set comprising a plurality of program instructions and a plurality of first acquisition instructions; generating, by the main processor for an acquisition engine, a plurality of second acquisition instructions based on the plurality of first acquisition instructions; executing, by the main processor, the plurality of program instructions during a scanning operation; and executing, by the acquisition engine, the second plurality of acquisition instructions during the scanning operation.

### BRIEF DESCRIPTION OF THE DRAWINGS

FIG. 1 is a schematic block diagram of a 2D scanning system according to one or more implementations.

FIG. 2 is a schematic block diagram of a control system according to one or more implementations.

FIG. 3 is a schematic block diagram of a processor system according to one or more implementations.

FIG. 4 is a flowchart of an example process associated with method to improve measurement accuracy for beam scanning application.

### DETAILED DESCRIPTION

The following detailed description of example implementations refers to the accompanying drawings. The same reference numbers in different drawings may identify the same or similar elements.

A 2D scan may be used to scan a 3D scene or a 3D object. While light may be scanned in two dimensions, a third dimension (e.g., a depth dimension) may be obtained from distance measurements. The distance measurements may be performed based on a time-of-flight of transmitted and reflected light beams. Traditional methods for performing a 2D scan involve pre-determined start and stop positions, a predetermined, fixed measurement acquisition scheme, a predetermined, fixed measurement acquisition rate, and a few additional parameters that may be preconfigured based on implementation. A beam scanner, such as a movable scanning mirror, may be configured to direct one or more light beams over a range of angles into a field-of-view based on a scanning pattern defined by one or more fixed parameters. A scanning pattern is then executed or rendered to advance or to complete a scan.

A measurement acquisition scheme may be temporal (e.g., a temporal acquisition scheme), during which measurements are taken at regular time intervals. Various factors may influence spatial locations of the measurements. As a number of measurements increases and a duration of a scan increases, an accuracy of the measurements compared to a prior scan tends to diminish. This loss of accuracy is due to certain variations being additive, such as successive accelerations, while others are multiplicative, such as fluctuations in temperature.

Alternatively, a measurement acquisition scheme may be angular (e.g., an angular acquisition scheme), during which measurements are taken at regular angular intervals of the beam scanner. The angular acquisition scheme has an advantage of minimizing an impact of most physical attributes of a scanning system that could otherwise degrade measurement accuracy. Nevertheless, while the angular acquisition scheme may be capable of measuring at fixed, regular angles, angular measurement acquisition typically lacks the ability to vary the angles during a scan or target a specific angle for measurement acquisition that is not one of the angles defined by a regular angular interval. Thus, current scanning systems are limited in ability to precisely measure a spontaneous area of interest in a scene to obtain exact, desired measurements and tend to be inflexible in configuration.

Some implementations are directed to improving measurement repeatability (e.g., an ability for successive scans to measure a same physical location over and over). In some examples, a method of beam steering is provided that uses angular measurement acquisition techniques, while maintaining a capability for temporal measurement acquisition. Additionally, the method may include alternating or switching between temporal measurement acquisition and angular measurement acquisition within a same scan.

In some implementations, a scanning system includes a main processor and an acquisition engine. The acquisition engine may be configured to amalgamate both temporal and angular acquisition schemes. A processor instruction set (e.g., machine instructions) for a main processor may be structured in such a way that the main processor can seamlessly switch between these two measurement acquisition schemes without inducing a performance bottleneck or a stall in the acquisition engine. For example, the main processor may read the processor instruction set comprising a plurality of program instructions and a plurality of first acquisition instructions. The main processor may execute the plurality of program instructions during a scanning operation. The main processor may generate a plurality of second acquisition instructions based on the plurality of first acquisition instructions and provide the plurality of second acquisition instructions to the acquisition engine. The plurality of acquisition instructions provided by the main processor to the acquisition engine may, in some cases, be communicated as a single summary instruction that the acquisition engine understands to represent a certain or contextual plurality of atomic acquisition instructions. The acquisition engine may execute the second plurality of acquisition instructions during the scanning operation, and perform a temporal acquisition scheme or an angular acquisition scheme based on the second plurality of acquisition instructions. Thus, the scanning system provides flexibility in which measurement acquisition scheme in performed, and may switch between the measurement acquisition schemes based on the processor instruction set. Moreover, acquisition control parameters may be adjusted during the scanning operation based on the processor instruction set. Thus, the measurement acquisition schemes may be dynamically configured during the scanning operation in order achieve tailored measurement acquisition profiles. For example, during an angular acquisition scheme, the scanning system may vary angles based on mathematical equations or be very specific by matching one acquisition instruction to one specific angle. Additionally, specific angles for measurement acquisition may be targeted that may not otherwise be possible during an angular acquisition scheme that is limited to regular angular intervals only.

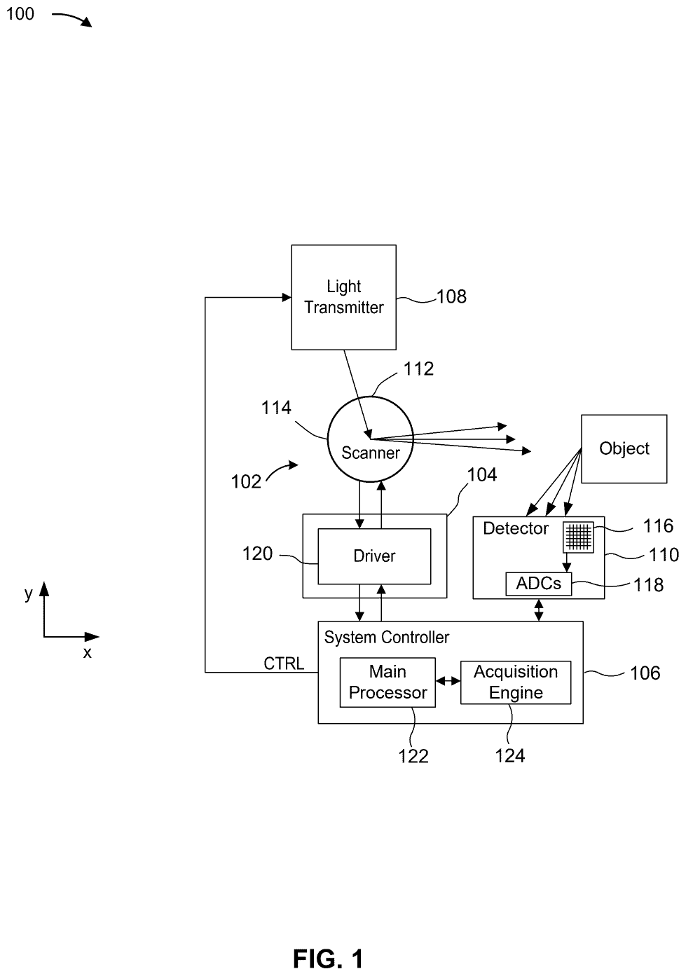

FIG. 1 is a schematic block diagram of a 2D scanning system 100 according to one or more implementations. In particular, the 2D scanning system 100 includes a beam scanner 102 configured to steer or otherwise deflect light beams according to a 2D scanning pattern for scanning 3D objects. The 2D scanning system 100 further includes a driver system 104, a system controller 106, and a light transmitter 108, and a detector 110.

The beam scanner 102 may be arranged to receive one or more transmitted light beams (e.g., optical signals) from the light transmitter 108 and steer (scan) the one or more transmitted light beams into the field-of-view to perform a scanning of the environment. In the example shown in FIG. 1, the beam scanner 102 may be a mechanical moving mirror and may be configured to rotate or oscillate via rotation about two scanning axes that are typically orthogonal to each other. For example, the two scanning axes may include a first scanning axis 112 that enables the beam scanner 102 to steer light in a first scanning direction (e.g., an x-direction) and a second scanning axis 114 that enables the beam scanner 102 to steer light in a second scanning direction (e.g., a y-direction). As a result, the beam scanner 102 can direct light beams over a range of angles in two dimensions according to the 2D scanning pattern. Thus, the beam scanner 102 can be used to scan the field-of-view in both scanning directions by changing an angle of deflection of the beam scanner 102 on each of the first scanning axis 112 and the second scanning axis 114.

In some implementations, the beam scanner 102 may be a galvanometer scanner. The galvanometer scanner may include a shaft for each scanning axis, a first galvanometer-based scanning motor that drives a rotation of a first shaft associated with the first scanning axis 112, a second galvanometer-based scanning motor that drives a rotation of a second shaft associated with the second scanning axis 114, an optical mirror mounted to both the first shaft and the second shaft, and a detector that provides positional feedback (e.g., an actual angle measurement for each scanning axis or a vector measurement) to the system controller 106. The driver system 104 may include a first servo driver for driving the first galvanometer-based scanning motor, and a second servo driver for driving the second galvanometer-based scanning motor. Each servo driver may generate a driving signal (e.g., a drive current) based on a command position (e.g., an angle setpoint) that is provided to the servo driver by a control loop. Each servo driver may supply the driving signal to a respective galvanometer-based scanning motor. The system controller 106 may monitor a difference representing an error between the command position (e.g., the angle setpoint) and an actual position (e.g., the actual angle measurement) to adjust the command position based on the difference.

In some implementations, the beam scanner 102 may include two mechanical moving mirrors arranged in series along a transmission path of a light beam such that a first mechanical moving mirror first receives a light beam and steers the light beam according to a respective deflection angle and a second mechanical moving mirror receives the light beam from the first mechanical moving mirror and steers the light beam according to a respective deflection angle. The two mechanical moving mirrors may each have a single scanning axis. For example, the first mechanical moving mirror may be associated with the first scanning axis 112, and the second mechanical moving mirror may be associated with the second scanning axis 114. As a result, the two mechanical moving mirrors may operate together to steer the light beam generated by the light transmitter 108 at an output deflection angle. In this way, the two mechanical moving mirrors can direct the light beam at a desired coordinate in the field-of-view.

A scan can be performed to illuminate an area referred to as a field-of-view. The scan, such as an oscillating horizontal scan (e.g., from left to right and right to left of a field-of-view), an oscillating vertical scan (e.g., from bottom to top and top to bottom of a field-of-view), or a combination thereof (e.g., a Lissajous scan or a raster scan) can illuminate the field-of-view in a continuous scan fashion. In some implementations, the 2D scanning system 100 may be configured to transmit successive light beams (e.g., as successive light pulses) in different scanning directions to scan the field-of-view. The beam scanner 102 can direct a transmitted light beam at a desired 2D measurement coordinate (e.g., an x-y coordinate) in the field-of-view, controlled by the system controller 106.

The light transmitter 108 may include one or more light sources, such as one or more laser diodes or one or more light emitting diodes, for generating one or more light beams. In some implementations, the light transmitter 108 may be configured to transmit a light beam as a continuous-wave light beam (e.g., frequency-modulated continuous wave (FMCW) or amplitude-modulated continuous wave (AMCW)) as the beam scanner 102 changes a transmission direction in order to target different 2D measurement coordinates. Control parameters of a continuous-wave modulation, such as amplitude or frequency, implemented by the light transmitter 108 may be configured according to a control signal CTRL received from the system controller 106. Alternatively, the light transmitter 108 may be configured to sequentially transmit a plurality of light beams (e.g., light pulses) as the beam scanner 102 changes a transmission direction in order to target different 2D measurement coordinates. A transmission sequence of the plurality of light beams and a timing thereof may be implemented by the light transmitter 108 according to the control signal CTRL received from the system controller 106.

A transmitted light beam may be backscattered by one or more objects back toward the 2D scanning system 100 as a reflected light beam, where the reflected light beam is detected by the detector 110 at a receiver side of the 2D scanning system 100. For example, the detector 110 may include a sensor 116 and one or more acquisition elements 118. The sensor 116 may be a photodetector array that converts each reflected light beam into one or more electric signals (e.g., current signals or voltage signals) that may be further processed by the 2D scanning system 100 to generate object data or an image. The one or more acquisition elements 118 may be coupled to the sensor 116 and may be configured to acquire measurements of the one or more electric signals (e.g., of the reflected light beam) based on a measurement acquisition scheme (e.g., temporal or angular). In some implementations, the one or more acquisition elements 118 may be analog-to-digital converters (ADCs) that have a controlled acquisition time based on the measurement acquisition scheme. In some implementations, the detector 110 may include transimpedance amplifiers (TIAs) that convert the photocurrents from the sensor 116 into corresponding voltages, and the one or more acquisition elements 118 sample the corresponding voltages. The acquisition time may be controlled by the system controller 106. An acquisition time may be a sampling time at which an ADC samples an electric signal to acquire a digital sample or digital value of the electric signal. For example, based on a temporal acquisition scheme, the one or more acquisition elements 118 may acquire measurements at regular time intervals. Based on an angular acquisition scheme, the one or more acquisition elements 118 may acquire measurements at regular angular intervals of the beam scanner 102. In such implementations, a desired 2D measurement coordinate may correspond to a particular acquisition time in a temporal domain or a particular acquisition angle of the beam scanner 102 in an angular domain.

The system controller 106 may receive electrical signals from the detector 110 (e.g., from the one or more acquisition elements 118) and perform signal processing on the measurements (e.g., on the digital signals) for object feature detection. In some implementations, the one or more acquisition elements 118 may be implemented in the system controller 106 instead of the detector 110. For continuous wave modulation, such as that used for an AMCW light beam, a radio frequency (RF) signal may be encoded onto an optical signal (e.g., a laser beam). A delay of a detected wave after reflection is measured at the receiver. In the case of AMCW, an intensity pattern, such as and RF pattern of the RF signal, is encoded on a transmitted optical power of the transmitted light beam. A free-space path encodes a phase shift on the RF signal, which can be detected by measuring an intermediate frequency after mixing a received intensity signal with a non-delayed version of the RF signal, used as a reference signal.

A digital signal provided by an acquisition element 118 may be encoded with the RF pattern that has been phase shifted based on the distance to the object. Thus, the distance can be determined from the measured phase shift. This is in contrast to pulsed modulation, in which a system measures distance to a 3D object by measuring the absolute time that a light pulse takes to travel from a source into the 3D scene and back, after reflection. The detector 110 and/or the system controller 106 may include a signal processor configured to, based on the measurements, calculate distances to an object from which the reflected light beam is reflected.

The driver system 104 may be configured to generate driving signals (e.g., actuation signals) to drive the beam scanner 102 about the first scanning axis 112 and the second scanning axis 114. In particular, the driver system 104 may be configured to apply the driving signals to an actuator structure of the beam scanner 102. In some implementations, the driver system 104 includes a driver 120 configured to drive the beam scanner 102 about the first scanning axis 112 and the second scanning axis 114. In implementations in which the beam scanner 102 is used as an oscillator, the driver 120 may be configured to drive an oscillation of the beam scanner 102 about the first scanning axis 112 at a first frequency, and drive an oscillation of the beam scanner 102 about the second scanning axis 114 at a second frequency.

The driver 120 may be configured to receive feedback information from the beam scanner 102, such as rotational position information. The system controller 106 may use the rotational position information to trigger light beams at the light transmitter 108 or measurements at the one or more acquisition elements 118. For example, the system controller 106 may use the rotational position information to set a transmission time of light transmitter 108 in order to target a particular 2D measurement coordinate of the 2D scanning pattern.

In some implementations, the system controller 106 may use the rotational position information to trigger the one or more acquisition elements 118 to acquire measurements at regular angular intervals of the beam scanner 102. For example, during the angular acquisition scheme, the one or more acquisition elements 118 may be configured to acquire the measurements at regular angular intervals of the beam scanner 102. The system controller 106 may monitor a rotational position of the beam scanner 102 based on the rotational position information, and trigger the measurements at one or more acquisition angles defined in one or more acquisition instructions. The measurements may be triggered at a regular angular interval defined by an acquisition control parameter, at acquisition angles (regular or irregular) defined by a mathematical formula, at acquisition angles defined by an acquisition pattern (regular or irregular), and/or at one or more specific acquisition angles. In some implementations, each acquisition instruction may specify one specific angle or a set of specific angles at which measurement acquisitions are to be taken.

In some implementations, the system controller 106 is configured to set a driving frequency of the beam scanner 102 for each scanning axis and is capable of synchronizing the oscillations about the first scanning axis 112 and the second scanning axis 114. In particular, the system controller 106 may be configured to control an actuation of the beam scanner 102 about each scanning axis by controlling the driving signals. The system controller 106 may control the frequency, the phase, the duty cycle, and/or a voltage level of the driving signals to control the actuations about the first scanning axis 112 and the second scanning axis 114. The actuation of the beam scanner 102 about a particular scanning axis controls its range of motion and scanning rate about that particular scanning axis.

The system controller 106 may be configured to control components of the 2D scanning system 100. In certain applications, the system controller 106 may also be configured to receive programming information with respect to a scanning operation and control one or more components based on the programming information. Thus, the system controller 106 may include both processing and control circuitry that is configured to generate control signals for controlling the components of the 2D scanning system 100. For example, the system controller 106 may include a main processor 122 and an acquisition engine 124. An “engine” may be a processing circuit comprising one or more processors, and may be configured to perform specific operations, such as measurement acquisition.

The main processor 122 may include a signal processor configured to, based on the measurements acquired by the one or more acquisition elements 118, calculate distances to an object (e.g., a target) from which a reflected light beam is reflected. The signal processor may include a field-programmable gate array (FPGA). In addition, the main processor 122 may be configured to execute a processor instruction set (e.g., machine instructions), and, based on executing the processor instruction set, generate control signals for controlling the 2D scanning system 100 to perform a 2D scan of the scanning area according to the 2D scanning pattern. For example, the main processor 122, in conjunction with control circuitry, may control the beam scanner 102, the driver system 104, and/or the light transmitter 108 based on one or more control parameters, defined in the processor instruction set, to implement a scanning operation. The main processor 122 may control the beam scanner 102 by controlling one or more parameters of the driver 120, such as the frequency, the phase, the duty cycle, and/or a voltage level of the driving signals used for driving each scanning axis 112 and 114. The main processor 122 may control the light transmitter 108 by controlling one or more parameters of the light transmitter 108, such as beam power, an amplitude and/or frequency of the optical signal, or an RF pattern of an RF signal that is encoded onto the optical signal. Thus, the main processor 122 may control a continuous-wave modulation of the light transmitter 108.

In some implementations, the processor instruction set may include a plurality of program instructions and a plurality of first acquisition instructions. The main processor 122 may read the processor instruction set and execute the plurality of program instructions during the scanning operation. In addition, the main processor 122 may generate a plurality of second acquisition instructions based on the plurality of first acquisition instructions and provide the plurality of second acquisition instructions to the acquisition engine 124. The plurality of second acquisition instructions provided by the main processor 122 to the acquisition engine 124 may, in some cases, be communicated as a single summary instruction that the acquisition engine 124 understands to represent a certain or contextual plurality of atomic acquisition instructions. The acquisition engine 124 may execute the second plurality of acquisition instructions during the scanning operation.

The plurality of program instructions may include a plurality of scanning instructions for controlling the light transmitter 108 and the beam scanner 102 (or driver 120) for generating the scanning pattern. Put another way, the main processor 122 may, based on executing the plurality of program instructions (e.g., the plurality of scanning instructions), generate first control signals for controlling the light transmitter 108 and the beam scanner 102 (or driver 120).

The acquisition engine 124 may, based on executing the plurality of second acquisition instructions, generate second control signals for controlling the one or more acquisition elements 118 according to respective acquisition schemes indicated in the plurality of second acquisition instructions. For example, the acquisition engine 124 may control, based on executing the plurality of second acquisition instructions, whether the one or more acquisition elements 118 acquire measurements based on the temporal acquisition scheme or the angular acquisition scheme. Each second acquisition instruction of the plurality of second acquisition instructions may indicate a respective acquisition scheme, including the temporal acquisition scheme or the angular acquisition scheme, for the one or more acquisition elements 118, and one or more acquisition control parameters for the respective acquisition scheme. The acquisition engine 124 may, based on executing a second acquisition instruction of the plurality of second acquisition instructions, generate at least one second control signal for controlling the one or more acquisition elements 118 according to a respective acquisition scheme indicated in the second acquisition instruction.

The one or more acquisition control parameters may include, based on the respective acquisition scheme being the temporal acquisition scheme, a respective acquisition time interval at which the one or more acquisition elements 118 are configured to acquire a respective plurality of measurements. Thus, a second acquisition instruction may define a regular time interval at which measurements are to be acquired by the one or more acquisition elements 118. In addition, the one or more acquisition control parameters may include, based on the respective acquisition scheme being the angular acquisition scheme, a respective acquisition angular interval at which the one or more acquisition elements 118 are configured to acquire a respective plurality of measurements. Thus, a second acquisition instruction may define a regular angular interval at which measurements are to be acquired by the one or more acquisition elements 118. In addition, the one or more acquisition control parameters may include a respective duration parameter that corresponds to an operational duration of the respective acquisition scheme.

Thus, each second acquisition instruction of the plurality of second acquisition instructions may indicate which type of acquisition scheme (e.g., temporal or angular) should be performed. Furthermore, each second acquisition instruction of the plurality of second acquisition instructions may indicate an acquisition interval (e.g., a time interval or an angular interval) to be used for the acquisition scheme associated with the second acquisition instruction. Furthermore, each second acquisition instruction of the plurality of second acquisition instructions may indicate an operational duration that the acquisition scheme associated with the second acquisition instruction is to be performed. The acquisition engine 124 may execute the plurality of second acquisition instructions in a sequential order. As a result, the type of acquisition scheme, the acquisition interval, and/or the operational duration may change as different second acquisition instructions are executed by the acquisition engine 124. In some implementations, the acquisition engine 124 may execute the plurality of second acquisition instructions during a continuous-wave transmission of the light transmitter 108. Thus, the acquisition engine 124 may change the type of acquisition scheme, the acquisition interval, and/or the operational duration as a continuous-wave light beam is transmitted.

Accordingly, the main processor 122 may offload measurement acquisition tasks and responsibilities to the acquisition engine 124, which may enable a more flexible configuration of the one or more acquisition elements 118 between distinct scanning operations or within a same scanning operation. For example, the acquisition engine 124 may execute the second plurality of acquisition instructions independently from an execution of the plurality of program instructions (e.g., scanning instructions) by the main processor 122. Thus, the main processor 122 and the acquisition engine 124 may operate asynchronously. In some implementations, the main processor 122 may, prior to the scanning operation, generate the plurality of second acquisition instructions and provide the plurality of second acquisition instructions to the acquisition engine 124. For example, during a system bootup operation, the main processor 122 may read the processor instruction set, and generate the plurality of second acquisition instructions based on the plurality of first acquisition instructions read in the processor instruction set. The main processor 122 load the plurality of second acquisition instructions into memory of the acquisition engine 124 prior to starting the scanning operation. During the scanning operation, the main processor 122 may skip the plurality of first acquisition instructions and execute only the plurality of program instructions from the processor instruction set.

In some implementations, each second acquisition instruction of the plurality of second acquisition instructions corresponds to a respective first acquisition instruction of the plurality of first acquisition instructions. In some implementations, the plurality of second acquisition instructions is substantially similar to the plurality of first acquisition instructions. For example, the main processor 122 may forward the plurality of first acquisition instructions to the acquisition engine 124 as the plurality of second acquisition instructions. In some implementations, the main processor 122 may decode the plurality of first acquisition instructions to generate the plurality of second acquisition instructions. For example, the main processor 122 may convert each first acquisition instruction of the plurality of first acquisition instructions into a respective second acquisition instruction of the plurality of second acquisition instructions. For example, the main processor 122 may extract the type of acquisition scheme and one or more acquisition control parameters from a first acquisition instruction to generate a respective second acquisition instruction. The plurality of second acquisition instructions provided by the main processor 122 to the acquisition engine 124 may, in some cases, be communicated as a single summary instruction that the acquisition engine 124 understands to represent a certain or contextual plurality of atomic acquisition instructions.

In some implementations, at least one second acquisition instruction of the plurality of second acquisition instructions associated with a scanning operation indicates the temporal acquisition scheme, and at least one further second acquisition instruction of the plurality of second acquisition instructions associated with the same scanning operation indicates the angular acquisition scheme. In some implementations, each second acquisition instruction of the plurality of second acquisition instructions associated with a scanning operation indicates the temporal acquisition scheme. In some implementations, each second acquisition instruction of the plurality of second acquisition instructions associated with a scanning operation indicates the angular acquisition scheme. Thus, a measurement acquisition methodology may use one type of acquisition scheme for an entire scanning operation or a mixture of both types of acquisition schemes for a scanning operation.

In some implementations, the main processor 122 may be configured to read a processor instruction set comprising a plurality of program instructions and a plurality of acquisition instructions. The main processor 122 may execute the plurality of program instructions during a scanning operation. The main processor 122 may preconfigure the acquisition engine 124 with the plurality of acquisition instructions. The acquisition engine 124 may execute the plurality of acquisition instructions during the scanning operation.

The main processor 122 may be a custom processor, a specialized processor, or a purpose-built processor configured to receive custom machine language instructions natively and execute the custom machine language instructions. The main processor 122 may be designed specifically for executing the custom machine language instructions to perform a customized 2D scan, whereas a general-purpose processor may not be able to execute the custom machine language instructions to perform the customized 2D scan. The customized 2D scan may be customized for one or more characteristics of the 2D scanning system 100, as well as based on different levels of interest corresponding to different regions (e.g., regions of interest) within a scanning area. The main processor 122 may be configured to, based on the custom machine language instructions, control and dynamically vary one or more scanning parameters in real-time while scanning the scanning area. In some implementations, the main processor 122 may be implemented as an application-specific integrated circuit (ASIC), an FPGA, or emulated in software executed on a custom processing device.

In some implementations, the object data may be used during a manufacturing process of an object (e.g., a vehicle) to detect whether a part is assembled correctly and/or satisfies one or more specifications. Thus, the object data may be used to detect manufacturing faults that may occur during the manufacturing process.

Accordingly, the 2D scanning system 100 may include a detector 110 that includes at least one sensor (e.g., sensor 116) and at least one signal processor (e.g., the main processor 122 or other additional processors and/or processing components) implemented, for example, in the system controller 106. Thus, aspects of the system controller 106 may be integrated in the detector 110, or vice versa. The detector 110 may generate electrical signals based on reflected light beams corresponding to the light beams transmitted by the light transmitter 108. The detector 110 may transmit the electrical signals to the at least one signal processor. The at least one signal processor may be configured to process the electrical signals to generate distance measurements based on the machine instructions for generating the object data. The at least one signal processor may be configured to analyze the object data based on the machine instructions to detect manufacturing faults and/or generate a 3D point cloud.

In some implementations, the 2D scanning system 100 may be implemented in a light detection and ranging (LIDAR) system.

As indicated above, FIG. 1 is provided as an example. Other examples may differ from what is described with regard to FIG. 1. In practice, the 2D scanning system 100 may include additional components, fewer components, different components, or differently arranged components than those shown in FIG. 1 without deviating from the disclosure provided above. In addition, in some implementations, the 2D scanning system 100 may include one or more additional mirrors to scan the field-of-view.

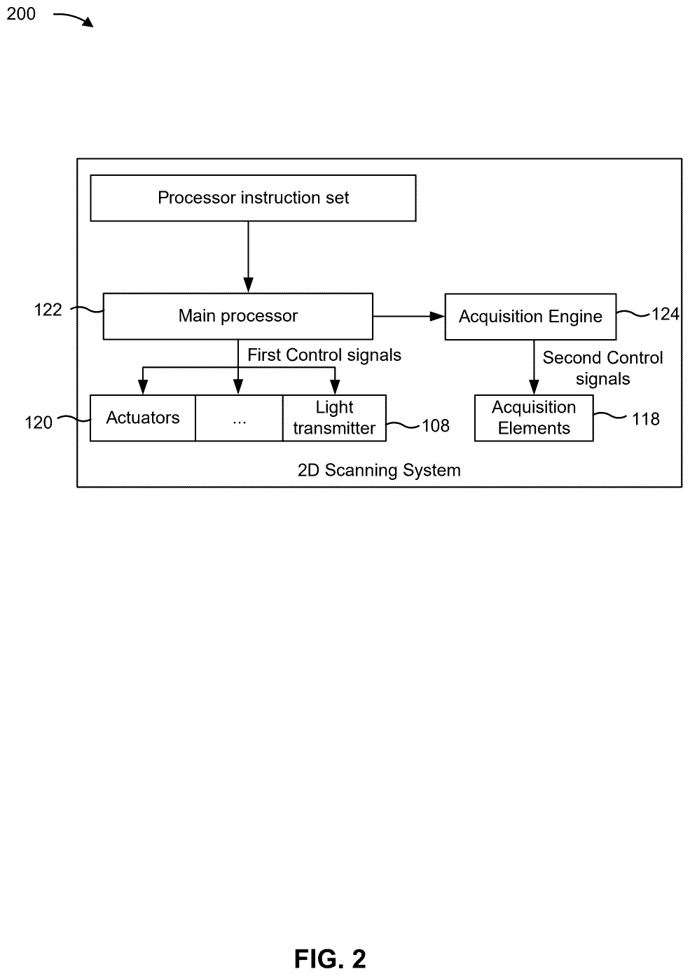

FIG. 2 is a schematic block diagram of a control system 200 according to one or more implementations. The control system 200 may be part of the 2D scanning system 100 described in connection with FIG. 1. The control system 200 may include the main processor 122 and the acquisition engine 124. The main processor 122 may receive a processor instruction set comprising a plurality of program instructions and a plurality of first acquisition instructions. The main processor 122 may execute the plurality of program instructions during a scanning operation. In addition, the main processor 122 may generate a plurality of second acquisition instructions based on the plurality of first acquisition instructions and provide the plurality of second acquisition instructions to the acquisition engine 124.

The main processor 122 may, based on executing the plurality of program instructions, generate first control signals for controlling actuators corresponding to the beam scanner 102 (or the driver 120) and for controlling the light transmitter 108. The plurality of program instructions may include a plurality of scanning instructions for controlling the beam scanner 102 (or the driver 120) and the light transmitter 108 for generating a scanning pattern.

The acquisition engine 124 may execute the second plurality of acquisition instructions during the scanning operation. The acquisition engine 124 may, based on executing the plurality of second acquisition instructions, generate second control signals for controlling the one or more acquisition elements 118, as described above in connection with FIG. 1.

In some implementations, the main processor 122 may be configured to read the processor instruction set comprising a plurality of program instructions and a plurality of acquisition instructions. The main processor 122 may execute the plurality of program instructions during a scanning operation. The main processor 122 may preconfigure the acquisition engine 124 with the plurality of acquisition instructions. The acquisition engine 124 may execute the plurality of acquisition instructions during the scanning operation.

As indicated above, FIG. 2 is provided as an example. Other examples may differ from what is described with regard to FIG. 2.

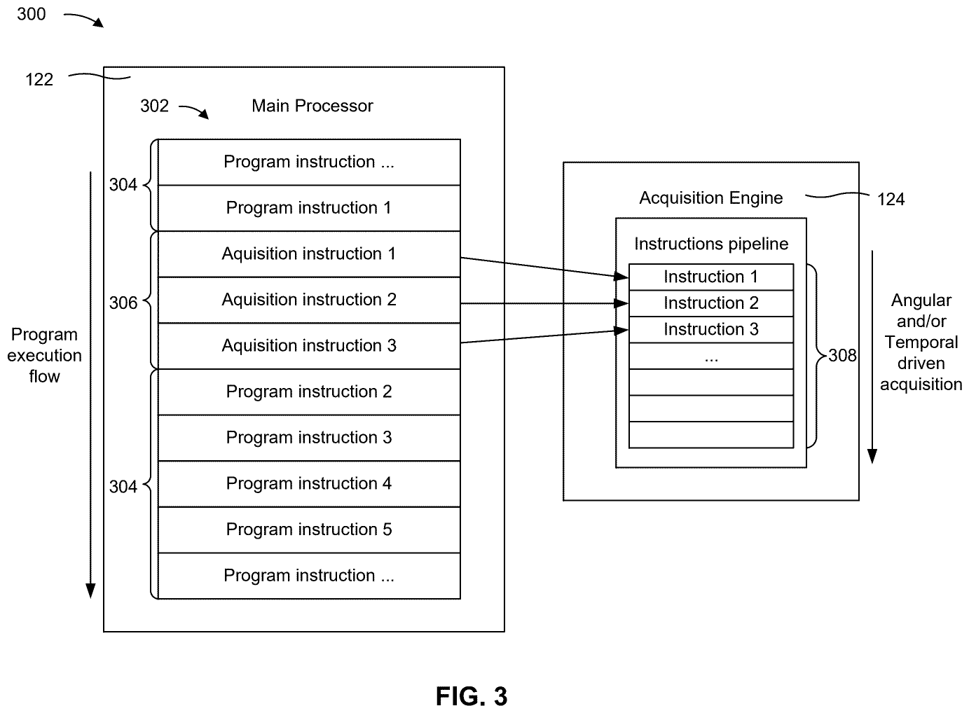

FIG. 3 is a schematic block diagram of a processor system 300 according to one or more implementations. The processor system 300 may be part of the 2D scanning system 100 described in connection with FIG. 1, and may be part of the control system 200 described in connection with FIG. 2.

The main processor 122 may read a processor instruction set 302 that includes plurality of program instructions 304 and a plurality of first acquisition instructions 306. The processor instruction set 302 may be a set of low-level machine language instructions for the main processor 122 to perform a scan and to perform related setup and signal processing as directed by the set of low-level machine language instructions. The machine language instructions may include, but are not limited to, memory access, variable assignment, variable manipulation, flow control, task/event sequencing, complex commands utilizing variables/parameters/memory, mathematical operators, comparison operators, and specialized commands. The processor instruction set 302 may be stored on a storage medium (e.g., a memory device) of the system controller 106 or on a storage medium the main processor 122 can access (e.g., by read operations).

The main processor 122 may execute the processor instruction set 302, and, based on processor instruction set 302, generate control signals for controlling the 2D scanning system 100 to perform 2D scan of a scanning area according to 2D scanning pattern. The program instructions 304 may cause the main processor 122 to generate first control signals for controlling the beam scanner 102 (or driver 120) and/or the light transmitter 108. In some implementations, the main processor 122 may control one or more lenses or other optical components to control a focus (or depth) of a transmitted light beam. The main processor 122 may execute the program instructions 304 in sequential order, with each program instruction 304 defining one or more control parameters for one or more components (e.g., the beam scanner 102, the driver 120, and/or the light transmitter 108).

The main processor 122 may generate a plurality of second acquisition instructions 308 based on the plurality of first acquisition instructions 306 and provide the plurality of second acquisition instructions 308 to the acquisition engine 124. In some implementations, the main processor 122 may, prior to the scanning operation, read the processor instruction set 302, generate the plurality of second acquisition instructions, and provide the plurality of second acquisition instructions to the acquisition engine 124. Thus, the main processor 122 may preconfigure the acquisition engine 124 with the plurality of second acquisition instructions prior to starting the scanning operation. The acquisition engine 124 may execute the plurality of acquisition instructions during the scanning operation. Each second acquisition instruction of the plurality of second acquisition instructions 308 may correspond to a respective first acquisition instruction of the plurality of first acquisition instructions 306. For example, the main processor 122 may convert each first acquisition instruction of the plurality of first acquisition instructions 306 into a respective second acquisition instruction of the plurality of second acquisition instructions 308. The main processor 122 may parse out or otherwise send the plurality of second acquisition instructions 308 from the processor instruction set 302 to the acquisition engine 124, and the acquisition engine 124 may store the plurality of second acquisition instructions 308 in an instructions pipeline for execution during the scanning operation for angular and/or temporal driven measurement acquisition. The acquisition engine 124 may carry out measurements as directed, with conditions that can be either temporal (based on a specified time lapse), angular (linked to a relative or absolute movement of the beam scanner 102), or a variable combination of both temporal and angular from one instruction to the next. Thus, the plurality of second acquisition instructions 308 may cause the acquisition engine 124 to generate second control signals for controlling an acquisition timing of the one or more acquisition elements 118. The acquisition engine 124 may execute the plurality of second acquisition instructions 308 in sequential order.

In some implementations, the plurality of second acquisition instructions 308 may include instructions for temporal measurement acquisition and/or angular measurement acquisition. Instructions for angular measurement acquisition may permit measurements to be accurately captured at specific angles in an x-dimension, a y-dimension, or a depth dimension (e.g., z-dimension). This in turn may provide flexibility to vary measurement density in multiple ways. In some implementations, each second acquisition instruction of the plurality of second acquisition instructions 308 may include an acquisition control parameter for each scanning axis, which may enable a same acquisition interval or different acquisition intervals to be defined for each scanning axis.

Thus, a processor implementation may include the acquisition engine 124 that is configured to execute specialized processor instructions, and can execute independently from the main processor 122, which performs non-acquisition tasks, such as beam steering. The acquisition engine 124 may be implemented as a second processor or an auxiliary processor that receives acquisition instructions from the main processor 122, and executes the acquisition instructions for measurement acquisition.

The main processor 122 may execute a scan in accordance with the program instructions 304 by manipulating pertinent actuators, mirrors, focus lenses, beam power, and other components related to beam steering and beam transmission. The acquisition engine 124 may carry out measurements as directed, with conditions that can be either temporal (based on a specified time lapse), angular (linked to a relative or absolute movement of the beam scanner 102), or a variable combination of both temporal and angular from one acquisition instruction to a next acquisition instruction. The acquisition engine 124 may amalgamate or mix both temporal and angular acquisition schemes. The acquisition engine 124 may perform a very specific and repetitive function or set of functions. The processor instruction set 302 and the processor system 300 may be designed in such a way that the processor system 300 can seamlessly switch between the temporal and angular acquisition techniques without inducing a performance bottleneck or causing the acquisition engine 124 to stall.

As indicated above, FIG. 3 is provided as an example. Other examples may differ from what is described with regard to FIG. 3.

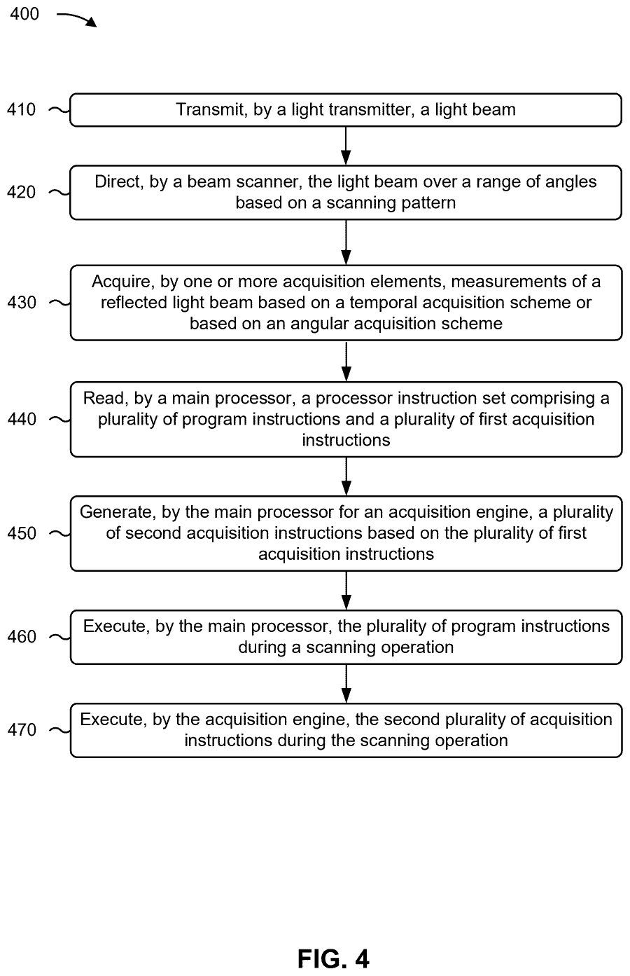

FIG. 4 is a flowchart of an example process 400 associated with a bean scanning method used to improve measurement accuracy for a beam scanning application. In some implementations, one or more process blocks of FIG. 4 are performed by a beam scanning system (e.g., beam scanning system 100). In some implementations, one or more process blocks of FIG. 4 may be performed by one or more components of the beam scanning system 100, such as beam scanner 102, driver system 104, system controller 106, light transmitter 108, and/or detector 110.

Process 400 may include additional implementations, such as any single implementation or any combination of implementations described below and/or in connection with one or more other processes described elsewhere herein.

As shown in FIG. 4, process 400 may include transmitting a light beam (block 410). For example, the light transmitter 108 may transmit a light beam, as described above.

As further shown in FIG. 4, process 400 may include directing the light beam over a range of angles based on a scanning pattern (block 420). For example, the beam scanner 102 may direct the light beam over a range of angles based on a scanning pattern, as described above.

As further shown in FIG. 4, process 400 may include acquiring, by one or more acquisition elements, measurements of a reflected light beam based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner (block 430). For example, the one or more acquisition elements 118 may acquire measurements of the reflected light beam based on the temporal acquisition scheme or based on the angular acquisition scheme, as described above.

As further shown in FIG. 4, process 400 may include reading a processor instruction set comprising a plurality of program instructions and a plurality of first acquisition instructions (block 440). For example, the main processor 122 may read the processor instruction set, as described above.

As further shown in FIG. 4, process 400 may include generating a plurality of second acquisition instructions based on the plurality of first acquisition instructions (block 450). For example, the main processor 122 may generate the plurality of second acquisition instructions, as described above.

As further shown in FIG. 4, process 400 may include executing the plurality of program instructions during a scanning operation (block 460). For example, the main processor 122 may execute the plurality of program instructions during the scanning operation, as described above.

As further shown in FIG. 4, process 400 may include executing the second plurality of acquisition instructions during the scanning operation (block 470). For example, the acquisition engine 124 may execute the second plurality of acquisition instructions during the scanning operation, as described above.

Process 400 may include additional implementations, such as any single implementation or any combination of implementations described below and/or in connection with one or more other processes described elsewhere herein.

In an implementation, each second acquisition instruction of the plurality of second acquisition instructions indicates a respective acquisition scheme, including the temporal acquisition scheme or the angular acquisition scheme, for the one or more acquisition elements, and one or more acquisition control parameters for the respective acquisition scheme.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:

Aspect 1: A beam scanning system, comprising: a light transmitter configured to transmit a light beam; a beam scanner configured to direct the light beam over a range of angles based on a scanning pattern; a detector comprising one or more acquisition elements configured to acquire measurements of a reflected light beam, corresponding to the light beam, based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner, wherein the detector comprises a signal processor configured to, based on the measurements, calculate distances to a target from which the reflected light beam is reflected; and a control system comprising a main processor and an acquisition engine coupled to the main processor, wherein the main processor is configured to read a processor instruction set comprising a plurality of program instructions and a plurality of first acquisition instructions, wherein the main processor is configured to execute the plurality of program instructions during a scanning operation, wherein the main processor is configured to generate a plurality of second acquisition instructions based on the plurality of first acquisition instructions and provide the plurality of second acquisition instructions to the acquisition engine, and wherein the acquisition engine is configured to execute the second plurality of acquisition instructions during the scanning operation.

Aspect 2: The beam scanning system of Aspect 1, wherein the acquisition engine is configured to execute the second plurality of acquisition instructions independently from an execution of the plurality of program instructions by the main processor.

Aspect 3: The beam scanning system of any of Aspects 1-2, wherein the main processor and the acquisition engine operate asynchronously.

Aspect 4: The beam scanning system of any of Aspects 1-3, wherein the main processor is configured to, prior to the scanning operation, generate the plurality of second acquisition instructions and provide the plurality of second acquisition instructions to the acquisition engine.

Aspect 5: The beam scanning system of any of Aspects 1-4, wherein the plurality of program instructions includes a plurality of scanning instructions for controlling the light transmitter and the beam scanner for generating the scanning pattern.

Aspect 6: The beam scanning system of any of Aspects 1-5, wherein the main processor is configured to, based on executing the plurality of program instructions, generate first control signals for controlling the light transmitter and the beam scanner.

Aspect 7: The beam scanning system of any of Aspects 1-6, wherein the acquisition engine is configured to, based on executing the plurality of second acquisition instructions, generate second control signals for controlling the one or more acquisition elements.

Aspect 8: The beam scanning system of any of Aspects 1-7, wherein each second acquisition instruction of the plurality of second acquisition instructions indicates a respective acquisition scheme, including the temporal acquisition scheme or the angular acquisition scheme, for the one or more acquisition elements, and one or more acquisition control parameters for the respective acquisition scheme.

Aspect 9: The beam scanning system of Aspect 8, wherein the acquisition engine is configured to, based on executing a second acquisition instruction of the plurality of second acquisition instructions, generate at least one second control signal for controlling the one or more acquisition elements according to a respective acquisition scheme indicated in the second acquisition instruction.

Aspect 10: The beam scanning system of Aspect 8, wherein the acquisition engine is configured to, based on executing the plurality of second acquisition instructions, generate second control signals for controlling the one or more acquisition elements according to respective acquisition schemes indicated in the plurality of second acquisition instructions.

Aspect 11: The beam scanning system of Aspect 10, wherein the acquisition engine is configured to execute the plurality of second acquisition instructions in a sequential order.

Aspect 12: The beam scanning system of Aspect 8, wherein at least one second acquisition instruction of the plurality of second acquisition instructions indicates the temporal acquisition scheme, and wherein at least one further second acquisition instruction of the plurality of second acquisition instructions indicates the angular acquisition scheme.

Aspect 13: The beam scanning system of Aspect 8, wherein each second acquisition instruction of the plurality of second acquisition instructions indicates the temporal acquisition scheme, or wherein each second acquisition instruction of the plurality of second acquisition instructions indicates the angular acquisition scheme.

Aspect 14: The beam scanning system of Aspect 8, wherein the one or more acquisition control parameters include: based on the respective acquisition scheme being the temporal acquisition scheme, a respective acquisition time interval at which the one or more acquisition elements are configured to acquire a respective plurality of measurements, and based on the respective acquisition scheme being the angular acquisition scheme, a respective acquisition angular interval at which the one or more acquisition elements are configured to acquire a respective plurality of measurements.

Aspect 15: The beam scanning system of Aspect 14, wherein the one or more acquisition control parameters include: a respective duration parameter that corresponds to an operational duration of the respective acquisition scheme.

Aspect 16: The beam scanning system of any of Aspects 1-15, wherein each second acquisition instruction of the plurality of second acquisition instructions corresponds to a respective first acquisition instruction of the plurality of first acquisition instructions.

Aspect 17: The beam scanning system of any of Aspects 1-16, wherein the main processor is configured to convert each first acquisition instruction of the plurality of first acquisition instructions into a respective second acquisition instruction of the plurality of second acquisition instructions.

Aspect 18: A beam scanning system, comprising: a light transmitter configured to transmit a light beam; a beam scanner configured to direct the light beam over a range of angles based on a scanning pattern; a detector comprising one or more acquisition elements configured to acquire measurements of a reflected light beam, corresponding to the light beam, based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner, wherein the detector comprises a signal processor configured to, based on the measurements, calculate distances to a target from which the reflected light beam is reflected; and a control system comprising a main processor and an acquisition engine coupled to the main processor, wherein the main processor is configured to read a processor instruction set comprising a plurality of program instructions and a plurality of acquisition instructions, wherein the main processor is configured to execute the plurality of program instructions during a scanning operation, wherein the main processor is configured to preconfigure the acquisition engine with the plurality of acquisition instructions, and wherein the acquisition engine is configured to execute the plurality of acquisition instructions during the scanning operation.

Aspect 19: The beam scanning system of Aspect 18, wherein the acquisition engine is configured to, based on executing the plurality of acquisition instructions, generate control signals for controlling the one or more acquisition elements.

Aspect 20: The beam scanning system of any of Aspects 18-19, wherein each acquisition instruction of the plurality of acquisition instructions indicates a respective acquisition scheme, including the temporal acquisition scheme or the angular acquisition scheme, for the one or more acquisition elements and one or more acquisition control parameters for the respective acquisition scheme.

Aspect 21: The beam scanning system of Aspect 20, wherein the acquisition engine is configured to, based on executing the plurality of acquisition instructions, generate control signals for controlling the one or more acquisition elements according to respective acquisition schemes indicated in the plurality of acquisition instructions.

Aspect 22: A beam scanning method, comprising: transmitting, by a light transmitter, a light beam; directing, by a beam scanner, the light beam over a range of angles based on a scanning pattern; acquiring, by one or more acquisition elements, measurements of a reflected light beam based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner; reading, by a main processor, a processor instruction set comprising a plurality of program instructions and a plurality of first acquisition instructions; generating, by the main processor for an acquisition engine, a plurality of second acquisition instructions based on the plurality of first acquisition instructions; executing, by the main processor, the plurality of program instructions during a scanning operation; and executing, by the acquisition engine, the second plurality of acquisition instructions during the scanning operation.

Aspect 23: The beam scanning method of Aspect 22, wherein each second acquisition instruction of the plurality of second acquisition instructions indicates a respective acquisition scheme, including the temporal acquisition scheme or the angular acquisition scheme, for the one or more acquisition elements, and one or more acquisition control parameters for the respective acquisition scheme.

Aspect 24: A system configured to perform one or more operations recited in one or more of Aspects 1-23.

Aspect 25: An apparatus comprising means for performing one or more operations recited in one or more of Aspects 1-23.

Aspect 26: A non-transitory computer-readable medium storing a set of instructions, the set of instructions comprising one or more instructions that, when executed by a device, cause the device to perform one or more operations recited in one or more of Aspects 1-23.

Aspect 27: A computer program product comprising instructions or code for executing one or more operations recited in one or more of Aspects 1-23.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item and/or such combinations also containing additional items that are none of a, b, or c.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A beam scanning system, comprising:
a light transmitter configured to transmit a light beam;
a beam scanner configured to direct the light beam over a range of angles based on a scanning pattern;
a detector comprising one or more acquisition elements configured to acquire measurements of a reflected light beam, corresponding to the light beam, based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner,
wherein the detector comprises a signal processor configured to, based on the measurements, calculate distances to a target from which the reflected light beam is reflected; and
a control system comprising a main processor and an acquisition engine coupled to the main processor,
wherein the main processor is configured to read a processor instruction set comprising a plurality of program instructions and a plurality of first acquisition instructions,
wherein the main processor is configured to execute the plurality of program instructions during a scanning operation,
wherein the main processor is configured to generate a plurality of second acquisition instructions based on the plurality of first acquisition instructions and provide the plurality of second acquisition instructions to the acquisition engine, and
wherein the acquisition engine is configured to execute the second plurality of acquisition instructions during the scanning operation.

2. The beam scanning system of claim 1, wherein the acquisition engine is configured to execute the second plurality of acquisition instructions independently from an execution of the plurality of program instructions by the main processor.

3. The beam scanning system of claim 1, wherein the main processor and the acquisition engine operate asynchronously.

4. The beam scanning system of claim 1, wherein the main processor is configured to, prior to the scanning operation, generate the plurality of second acquisition instructions and provide the plurality of second acquisition instructions to the acquisition engine.

5. The beam scanning system of claim 1, wherein the plurality of program instructions includes a plurality of scanning instructions for controlling the light transmitter and the beam scanner for generating the scanning pattern.

6. The beam scanning system of claim 1, wherein the main processor is configured to, based on executing the plurality of program instructions, generate first control signals for controlling the light transmitter and the beam scanner.

7. The beam scanning system of claim 1, wherein the acquisition engine is configured to, based on executing the plurality of second acquisition instructions, generate second control signals for controlling the one or more acquisition elements.

8. The beam scanning system of claim 1, wherein each second acquisition instruction of the plurality of second acquisition instructions indicates a respective acquisition scheme, including the temporal acquisition scheme or the angular acquisition scheme, for the one or more acquisition elements, and one or more acquisition control parameters for the respective acquisition scheme.

9. The beam scanning system of claim 8, wherein the acquisition engine is configured to, based on executing a second acquisition instruction of the plurality of second acquisition instructions, generate at least one second control signal for controlling the one or more acquisition elements according to a respective acquisition scheme indicated in the second acquisition instruction.

10. The beam scanning system of claim 8, wherein the acquisition engine is configured to, based on executing the plurality of second acquisition instructions, generate second control signals for controlling the one or more acquisition elements according to respective acquisition schemes indicated in the plurality of second acquisition instructions.

11. The beam scanning system of claim 10, wherein the acquisition engine is configured to execute the plurality of second acquisition instructions in a sequential order.

12. The beam scanning system of claim 8, wherein at least one second acquisition instruction of the plurality of second acquisition instructions indicates the temporal acquisition scheme, and
wherein at least one further second acquisition instruction of the plurality of second acquisition instructions indicates the angular acquisition scheme.

13. The beam scanning system of claim 8, wherein each second acquisition instruction of the plurality of second acquisition instructions indicates the temporal acquisition scheme, or
wherein each second acquisition instruction of the plurality of second acquisition instructions indicates the angular acquisition scheme.

14. The beam scanning system of claim 8, wherein the one or more acquisition control parameters include:
based on the respective acquisition scheme being the temporal acquisition scheme, a respective acquisition time interval at which the one or more acquisition elements are configured to acquire a respective plurality of measurements, and
based on the respective acquisition scheme being the angular acquisition scheme, a respective acquisition angular interval at which the one or more acquisition elements are configured to acquire a respective plurality of measurements.

15. The beam scanning system of claim 14, wherein the one or more acquisition control parameters include:
a respective duration parameter that corresponds to an operational duration of the respective acquisition scheme.

16. The beam scanning system of claim 1, wherein each second acquisition instruction of the plurality of second acquisition instructions corresponds to a respective first acquisition instruction of the plurality of first acquisition instructions.

17. The beam scanning system of claim 1, wherein the main processor is configured to convert each first acquisition instruction of the plurality of first acquisition instructions into a respective second acquisition instruction of the plurality of second acquisition instructions.

18. A beam scanning system, comprising:
a light transmitter configured to transmit a light beam;
a beam scanner configured to direct the light beam over a range of angles based on a scanning pattern;
a detector comprising one or more acquisition elements configured to acquire measurements of a reflected light beam, corresponding to the light beam, based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner,
wherein the detector comprises a signal processor configured to, based on the measurements, calculate distances to a target from which the reflected light beam is reflected; and
a control system comprising a main processor and an acquisition engine coupled to the main processor,
wherein the main processor is configured to read a processor instruction set comprising a plurality of program instructions and a plurality of acquisition instructions,
wherein the main processor is configured to execute the plurality of program instructions during a scanning operation,
wherein the main processor is configured to preconfigure the acquisition engine with the plurality of acquisition instructions, and
wherein the acquisition engine is configured to execute the plurality of acquisition instructions during the scanning operation.

19. The beam scanning system of claim 18, wherein the acquisition engine is configured to, based on executing the plurality of acquisition instructions, generate control signals for controlling the one or more acquisition elements.

20. The beam scanning system of claim 18, wherein each acquisition instruction of the plurality of acquisition instructions indicates a respective acquisition scheme, including the temporal acquisition scheme or the angular acquisition scheme, for the one or more acquisition elements and one or more acquisition control parameters for the respective acquisition scheme.

21. The beam scanning system of claim 20, wherein the acquisition engine is configured to, based on executing the plurality of acquisition instructions, generate control signals for controlling the one or more acquisition elements according to respective acquisition schemes indicated in the plurality of acquisition instructions.

22. A beam scanning method, comprising:
transmitting, by a light transmitter, a light beam;
directing, by a beam scanner, the light beam over a range of angles based on a scanning pattern;
acquiring, by one or more acquisition elements, measurements of a reflected light beam based on a temporal acquisition scheme, during which the one or more acquisition elements are configured to acquire the measurements at regular time intervals, or based on an angular acquisition scheme, during which the one or more acquisition elements are configured to acquire the measurements at regular angular intervals of the beam scanner;
reading, by a main processor, a processor instruction set comprising a plurality of program instructions and a plurality of first acquisition instructions;
generating, by the main processor for an acquisition engine, a plurality of second acquisition instructions based on the plurality of first acquisition instructions;
executing, by the main processor, the plurality of program instructions during a scanning operation; and
executing, by the acquisition engine, the second plurality of acquisition instructions during the scanning operation.

23. The beam scanning method of claim 22, wherein each second acquisition instruction of the plurality of second acquisition instructions indicates a respective acquisition scheme, including the temporal acquisition scheme or the angular acquisition scheme, for the one or more acquisition elements, and one or more acquisition control parameters for the respective acquisition scheme.
